(19) United States
(12) Patent Application Publication
(10) Pub. No.: US 2005/0097554 A1
(43) Pub. Date: May 5, 2005

(54) Charge rationing aware scheduler

(76) Inventor: David Christopher Burden, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,035

(22) Filed: Nov. 3, 2003

(51) Int. Cl. G06F 9/46

(52) U.S. Cl. 718/100

(57) ABSTRACT

Systems, methodologies, media, and other embodiments associated charge rationing aware scheduling are provided. One exemplary system includes a scheduling logic configured to determine the charge rationing status of a processor, to examine properties of executables waiting to be executed on the processor, and to select an executable for execution by the processor based on the charge rationing status of the processor and the properties of the executable.

### BACKGROUND

Computer processors may have the ability to report variable operating attributes. For example, frequency scaleable processors may report their operating frequency. Similarly, voltage scaleable processors may report their operating voltage. Conventionally, schedulers may have examined environment data like available power and selected an executable to run. The executable would reset the operating attributes to achieve a desired result. For example, a process may have included instructions to reset the processor frequency to a desired frequency and to reset the voltage to a desired voltage. These schedulers have been employed, for example, in applications that are concerned with conserving system power (e.g., Mars rover, handheld embedded systems). These schedulers are concerned with manipulating system power by manipulating properties of the following equations:
V=IR, (where V=voltage, I=current, R=resistance)
P=V¹, (where P=power)
p≈f V², (where f=frequency), and
P_{d}≈C_{ef}*V_{dd}²*f (where P_{d}=dynamic power, C_{ef}=switch capacitance, and V_{dd}=supply voltage)

For example, a power conserving scheduler may schedule a process because the process can set the processor to a lower voltage and then schedule a second process that can set the frequency to a lower frequency. In this way, the power conserving scheduler manipulates power consumption by setting processor attributes like voltage and frequency. But these types of schedulers assume that the processor attributes like voltage and frequency can be directly programmatically and/or electronically controlled (e.g., set, reset) by the scheduler and/or the scheduled process.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example system that includes a charge rationing aware scheduling logic.

FIG. 2 illustrates another example system that includes a charge rationing aware scheduling logic.

FIG. 3 illustrates an example system that includes a charge rationing aware scheduling logic and a test processor.

FIG. 4 illustrates an example charge rationing aware scheduling method.

FIG. 5 illustrates another example charge rationing aware scheduling method.

FIG. 6 illustrates an example computing environment in which example systems and methods that concern charge rationing aware scheduling can operate.

FIG. 7 illustrates an example image forming device in which example charge rationing aware scheduling systems and methods can operate.

### DETAILED DESCRIPTION

This application describes example systems, methods, computer-readable mediums and so on associated with charge rationing aware scheduling. The example systems and methods determine a processor state (e.g., power consumption rate, operating frequency) and select and/or schedule executables (e.g., processes, threads) based on the processor state and how the process(es) will affect or be affected by the processor state. Generally the feedback upon which scheduling may be performed is the current operating frequency of the processor for which a process will be scheduled.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, a memory stick, a floppy disk, a flexible disk, a hard disk, a magnetic tape, other magnetic medium, a CD-ROM, other optical medium, punch cards, paper tape, other physical medium with patterns of holes, an EPROM, a FLASH-EPROM, or other memory chip or card, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an ASIC, a programmed logic device, a memory device containing instructions, or the like. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Signal”, as used herein, includes but is not limited to one or more electrical or optical signals, analog or digital, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, machine, firmware, microcode, and/or other languages and tools. Software, whether an entire system or a component of a system, may be embodied as an article of manufacture and maintained as part of a computer-readable medium as defined previously. Another form of the software may include signals that transmit program code of the software to a recipient over a network or other communication medium.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, examining, analyzing, displaying, or the like, refer to actions and processes of a computer system, logic, processor, or similar electronic device that manipulates and transforms data represented as physical (electronic) quantities.

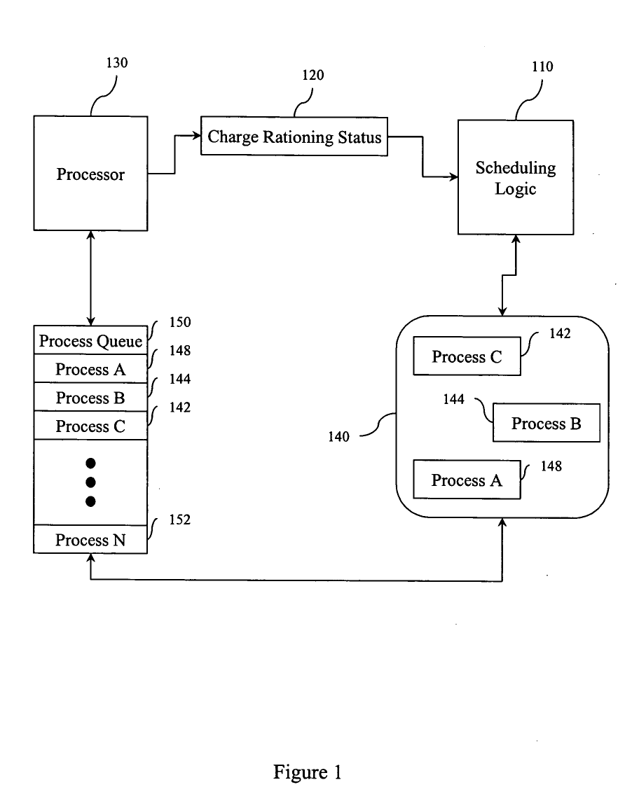

FIG. 1 illustrates an example system that includes a scheduling logic 110. The scheduling logic 110 may be configured, for example, to determine the charge rationing status 120 of a frequency scaleable processor 130. Generally, the charge rationing status 120 is related to the operating frequency of the processor 130. Determining the charge rationing status 120 of the processor 130 may include, for example, determining an operating frequency of the processor 130. By way of illustration, the frequency scaleable processor 130 may decrease its operating frequency in response to certain power demands or the effects of certain power demands. For example, if the processor 130 runs at a relatively high power consumption rate, the processor 130 may heat up. To prevent heat damage, the processor 130 may lower its operating frequency in an attempt to cool down. Once cooled down, the processor 130 may then increase its operating frequency. Thus, the charge rationing status 120 of the frequency scaleable processor 130 may be determined by, for example, monitoring the operating frequency of the processor 130 and changes thereto.

While operating frequency is described above, in another example, the charge rationing status 120 of the processor 130 may be determined by evaluating data including, but not limited to, an operating frequency of the processor 130, an operating frequency history of the processor 130, an amount by which the processor 130 frequency changed, and a frequency shift indicator. The information that is examined to determine the charge rationing status 120 may be delivered by, for example, an interrupt. Additionally, and/or alternatively, the information may be stored in a charge rationing data associated with the processor 130. Thus, in one example, the processor 130 may include one or more registers that can store data associated with the charge rationing status 120. For example, a register may store the operating frequency of the processor 130. Thus, in one example, if an interrupt were generated by the processor 130, then the scheduling logic 110 could read the register to determine the operating frequency of the processor 130. While a register is described, it is to be appreciated that other apparatus like a memory could be employed.

By comparing the current operating frequency to one or more past operating frequencies, the scheduling logic 110 could determine the charge rationing status 120 of the processor 130. By way of illustration, if the operating frequency is decreasing, then the scheduling logic 110 could determine that the processor 130 may be trying to account for the effects (e.g., heat) of prolonged relatively high power consumption. By way of further illustration, if the operating frequency is increasing, then the scheduling logic 110 could determine that the processor 130 may have recovered from the effects of prior prolonged relatively high power consumption. The recovery could be due, for example, to the processor 130 running processes at a lower frequency, consuming less power and thus cooling down.

The scheduling logic 110 may also be configured to examine selected properties of executables waiting to be scheduled for execution on the processor 130. The executables may be, for example, processes, threads, and the like. For example, a set 140 of executable processes (e.g., processes 142 and 144 through 148) may be awaiting execution on the processor 130. The properties associated with a waiting executable can include, but are not limited to, the identity of the executable, whether the executable is associated with a processor frequency decrease, whether the executable is associated with a processor frequency increase, whether the executable is associated with a stable processor frequency, power attributes (e.g., maximum power consumption) and so on.

The scheduling logic 110 may, for example, be configured to select an executable for execution by the processor 130 based, at least in part, on the charge rationing status 120 of the processor 130 and the selected property or properties. Once the scheduling logic 110 has selected an executable for execution by the processor 130, the scheduling logic 110 may generate a signal that causes the executable to be scheduled for execution. For example, the scheduling logic 110 may pass the entry address of the executable to the processor 130, may enter a process identifier in an address register in the processor 130, and so on.

In one example, the scheduling logic 110 may interact with a schedule data store 150 that is configured to store a schedule data associated with an order in which executables will be executed by the processor 130. For example, the schedule data store 150 may be a process queue that stores the process identifiers and/or entry addresses of executables to be executed by the processor 130. Thus, the scheduling logic 110 may be further configured to determine an execution order for executables based, at least in part, on the charge rationing status 120 of the processor 130, the schedule data in the schedule data store 150, and the selected properties. After determining the execution order, the scheduling logic 110 may generate a signal(s) that causes the selective arrangement of the schedule data in the schedule data store 150.

By way of illustration, the set of waiting executables may include several processes (e.g., processes 142, and 144 through 148. The processes may be associated with data that identifies how they have affected the processor 130 in the past, how the processes may affect the processor 130 under various conditions, conditions under which processes would prefer to run, and the like. By examining the charge rationing status 120, the scheduling logic 110 may determine that Process A 148 should be at the front of the process queue 150. For example, the charge rationing status 120 may indicate that the processor 130 is operating at a relatively low operating frequency and that a less power intensive process like Process A 148 should be run next to allow the processor 130 an opportunity to cool down. Anticipating that running Process A 148 will allow the processor 130 to return to a higher operating frequency, the scheduling logic 110 may therefore determine that Process B 144, which may benefit from a relatively higher operating frequency, should be scheduled after Process A 148. Predicting that running Process B 144 may cause the processor 130 to heat up and therefore switch to a lower operating frequency, the scheduling logic 110 may therefore schedule Process C 142 after Process B 144, where Process C 142 can run at a lower operating frequency with a relatively lower power consumption and thus offer processor 130 another chance to cool down. While three processes are described, it is to be appreciated that a greater and/or lesser number of processes may be available to schedule for execution by the processor 130. While processes are discussed, it is also to be appreciated that other executables like threads can be processed. Similarly, while a process queue 150 is described, it is to be appreciated that other data structures like lists, linked lists, tables, trees, and so on that can be organized by the order of execution can be employed.

The scheduling logic 110 may produce an initial ordering in the data store 150. The scheduling logic 110 may be further configured, however, to reorder or to have reordered on its behalf the schedule data in the schedule data store 130. The reordering may occur selectively, for example, in response to a change in the charge rationing status 120 of the processor 130. For example, while the scheduling logic 110 may have anticipated that running Process A 148 would offer the processor 130 an opportunity to cool off and thus return to a higher operating frequency, Process A 148 may have run at a higher than expected power consumption causing the processor 130 to further slow down. Thus, when the change in the charge rationing status 120 is detected, the scheduling logic 110 may reorder the data in the data store 150 to move Process C 142 ahead of Process B 144 to provide the processor 130 with an opportunity to cool off.

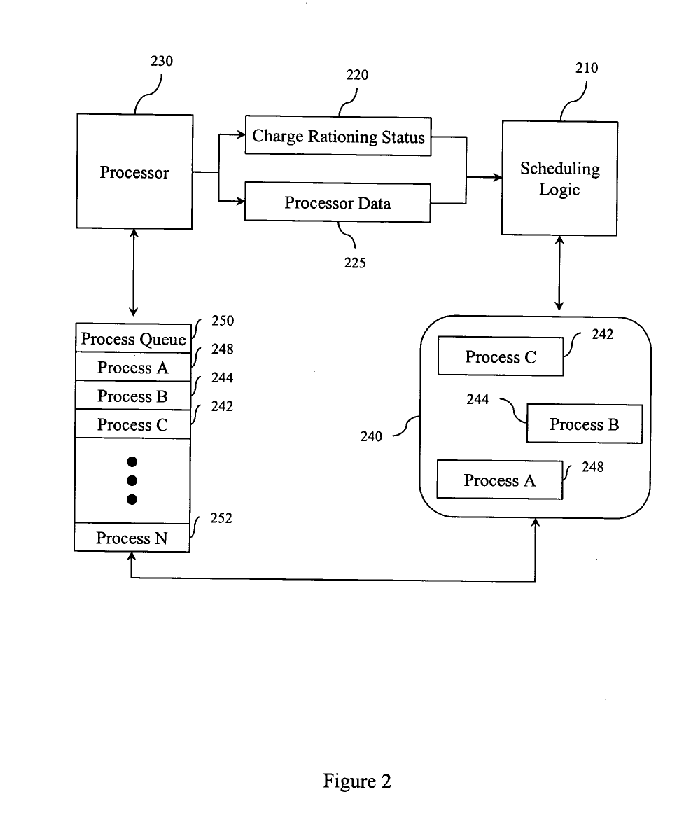

FIG. 2 illustrates an example system that includes a scheduling logic 210 that is configured to determine a charge rationing status 220 of a processor 230. Generally, the charge rationing status 220 will be related to the operating frequency of the processor 230. The scheduling logic 210 may also be configured to examine a processor data 225 associated with the processor 230. For example, the processor data 225 can include, but is not limited to, a temperature of the processor 230, a temperature history of the processor 230, changes in the temperature of the processor 230, a power consumption of the processor 230, a power consumption history of the processor 230, changes in the power consumption of the processor 230, a current flowing through the processor 230, a historical current flow through the processor 230, and changes in current flowing through the processor 230. The processor data 225 can facilitate determining the charge rationing status 220 of the processor 230 and/or the effects, (e.g., instant, historical, anticipated), of various processes on the processor 230.

Thus, the scheduling logic 210 may be further configured to select the executable for execution by the processor 230 based on the processor data 225, the charge rationing status 220, and properties associated with executables. By way of illustration, the scheduling logic 210 may examine properties associated with an executable and determine that a certain executable is likely to draw a relatively high amount of current. Thus, the scheduling logic 210 may schedule the executable with other similar processes so that a relatively constant current will flow into the processor 230. This can facilitate reacting to the charge rationing behaviors of the processor 230 like frequency scaling.

In one example, the scheduling logic 210 is further configured to determine an execution order for an executable based on the processor data, the charge rationing status 220, and so on. Thus, the scheduling logic 210 may rearrange and/or cause the rearrangement of schedule data in a schedule data store 250. For example, after examining the charge rationing status 220, processor data 225 and one or more selected properties of the processes in a set 240 of processes, the scheduling logic 210 may arrange schedule data in the schedule data store 250 to facilitate maintaining a relatively lower frequency in processor 230.

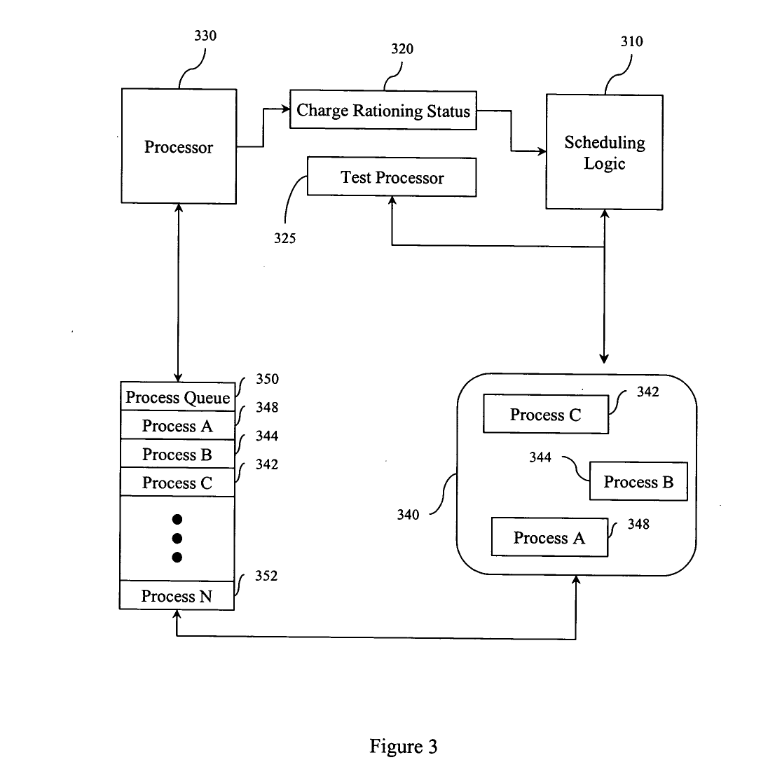

FIG. 3 illustrates another example system that includes a scheduling logic 310 that is configured to determine a charge rationing status 320 of a processor 330. The charge rationing status 320 may be related, for example, to the frequency of the processor 330. The scheduling logic 310 may also examine selected properties of executables waiting to be scheduled for execution on the processor 330. The system may therefore include a test processor 325 that facilitates characterizing, for example, the power consumption attributes of an executable. In one example, the test processor 325 is configured to execute an executable and monitor properties (e.g., heat, current, power) of the test processor 325 and/or the executable while the executable is executing. Monitoring properties of the test processor 325 facilitates producing data that characterize the effects on a processor of executing the executable. The data can characterize an executable on attributes including, but not limited to, an actual power rating during execution, an anticipated power rating during execution, an actual execution time, an anticipated execution time, an actual heat produced during execution, an anticipated heat produced during execution, an actual current during execution, and an anticipated current during execution. The “actual” data can be collected by monitoring the test processor 325 and/or the executable during execution. The “predicted” data may be provided by a process analyzer (not illustrated) that is configured to predict various executable characteristics.

In one example, the scheduling logic 310 is further configured to determine an execution order for an executable based on the characterizing data and its relationship to the charge rationing status 320. Thus, the scheduling logic 310 may rearrange and/or cause the rearrangement of schedule data in a schedule data store 350. For example, after the test processor 325 test executes the processes in a set 340 of processes, it may arrange schedule data in the schedule data store 350 to facilitate maintaining a relatively higher frequency in processor 330.

The example systems described above may be embedded in a variety of devices including, but not limited to, an image forming device, a computer, a cellular telephone, and the like. Similarly, the example methods described below may be performed by devices like printers, computers, cellular telephones, and so on.

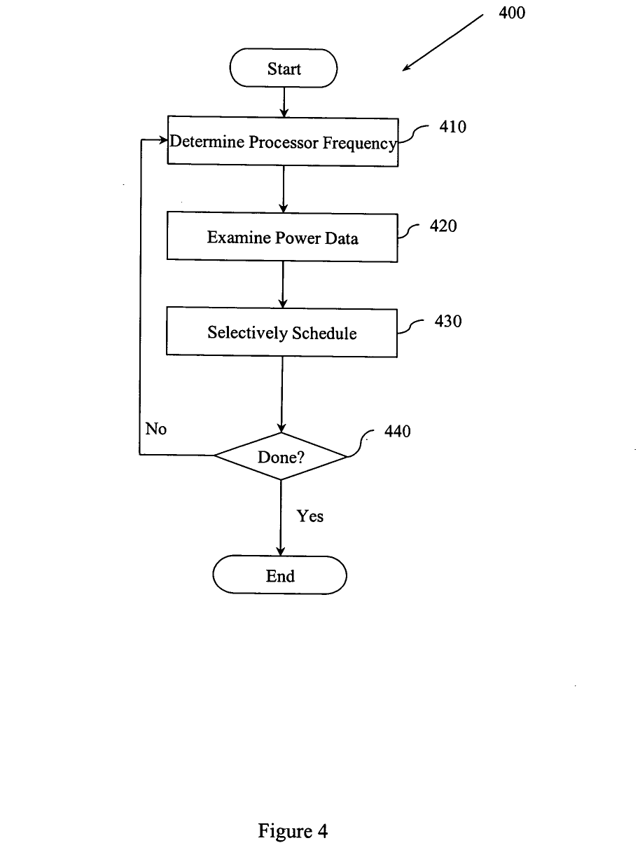

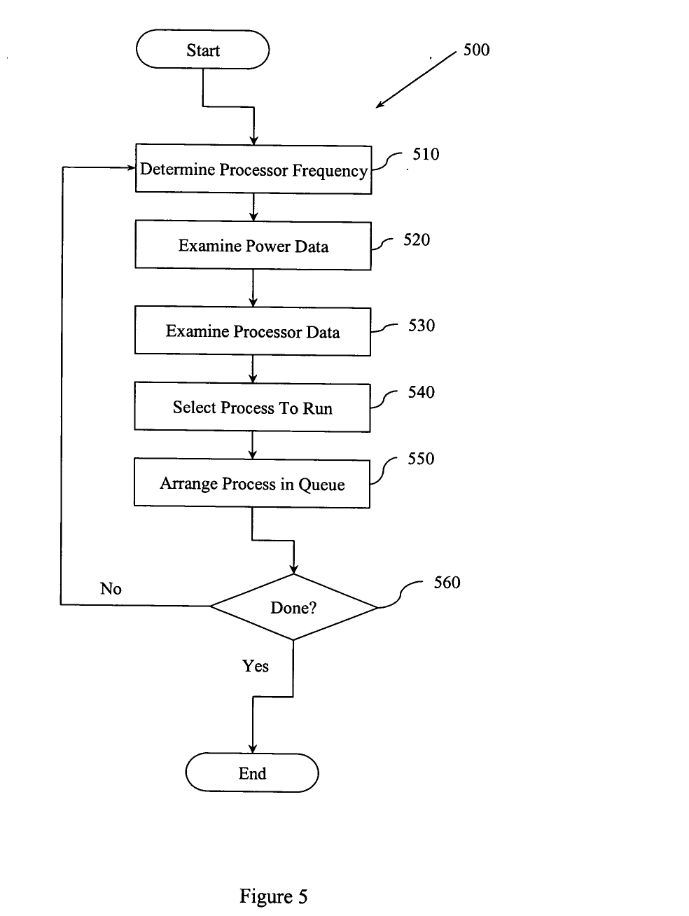

Example methods may be better appreciated with reference to the flow diagrams of FIGS. 4 and 5. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as processor executable instructions and/or operations stored on a computer-readable medium.

In the flow diagrams, blocks denote “processing blocks” that may be implemented, for example, in software. Additionally and/or alternatively, the processing blocks may represent functions and/or actions performed by functionally equivalent circuits like a digital signal processor (DSP), an ASIC, and the like.

A flow diagram does not depict syntax for any particular programming language, methodology, or style (e.g., procedural, object-oriented). Rather, a flow diagram illustrates functional information one skilled in the art may employ to fabricate circuits, generate software, or use a combination of hardware and software to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 4 illustrates an example charge rationing aware scheduling method 400. The method 400 may include, at 410, determining an operating frequency of a frequency scaleable processor. The operating frequency may be determined by, for example, examining a data store (e.g., register) in the processor that stores the operating frequency, analyzing an interrupt(s) or message(s) from the processor, and so on.

The method 400 may also include, at 420, examining a power data associated with a process. The power data may, for example, describe events associated with running a process. The events can include, but are not limited to, identifying that the process has not been run yet and thus no run time characterizing data is associated with the process, identifying that the processor frequency increased when the process was run, identifying that the processor frequency decreased when the process was run, and identifying that the processor frequency remained constant and/or substantially constant when the process was run. These events can facilitate identifying a process to present to the processor for execution, and/or the order in which processes may be scheduled.

Thus, the method 400 includes, at 430, selectively scheduling process(es) for processing by the processor based on the processor operating frequency and the power data. Selectively scheduling the process for processing may include, for example, generating a signal(s) that causes the processor to execute the process. For example, an entry address may be deposited in a processor register and an interrupt generated to cause the processor to task switch to that process. In another example, selectively scheduling the process for processing may include generating a signal(s) that cause the process to be logically located at a selected location in a data structure that is ordered by process schedule order. For example, a process identifier (PID) may be passed to a process queue in an “insert at” command. In another example, selectively scheduling the process for processing may include storing values in a data structure that is ordered by process schedule order. For example, the method may write the process execution entry address into a process execution table at an appropriate location.

While the method 400 describes processes it is to be appreciated that other executables like threads may be similarly scheduled. Furthermore, while FIG. 4 illustrates various actions occurring in serial, it is to be appreciated that various actions illustrated in FIG. 4 could occur substantially in parallel. By way of illustration, a first process could monitor a processor charge rationing status, a second process could examine power data, and a third process could selectively schedule processes to execute based on the outputs from the first and second processes. While three processes are described, it is to be appreciated that a greater and/or lesser number of processes could be employed and that lightweight processes, regular processes, threads, and other approaches could be employed.

FIG. 5 illustrates another example charge rationing aware method 500. The method 500 may include, at 510, determining the operating frequency of a frequency scaleable processor. The method 500 may also include, at 520, examining a power data associated with a process. The method 500 may also include, at 530, examining a processor data associated with the frequency scaleable processor. The processor data can describe attributes including, but not limited to, a processor temperature, a processor temperature history, changes in the processor temperature, a processor power consumption, a processor power consumption history, changes in the processor power consumption, a current flowing through the processor, a history of current flow through the processor, and changes in current flowing through the processor.

Thus, the method 500 includes, at 540, selectively scheduling a process(es) for processing based, at least in part, on the processor data, the processor frequency, and the power data. Additionally, and/or alternatively, the method 500 may include, at 550, causing the arrangement of and/or arranging a process(es) in a process queue that is available to the processor. Thus, processes may be arranged in the process queue in an order that depends on, for example, the charge rationing status (e.g., frequency) of the processor on which the processes will run and the anticipated effects the process(es) will have on the processor.

While the method 500 describes processes it is to be appreciated that other executables like threads may be similarly scheduled. Furthermore, while FIG. 5 illustrates various actions occurring in serial, it is to be appreciated that various actions illustrated in FIG. 5 could occur substantially in parallel. By way of illustration, a first process could determine the charge rationing status, a second process could analyze power data, a third process could analyze processor data, a fourth process could select the next process to execute, and a fifth process could insert the selected process in a process queue. While five processes are described, it is to be appreciated that a greater and/or lesser number of processes could be employed and that lightweight processes, regular processes, threads, and other approaches could be employed.

In one example, a computer-readable medium may store processor executable instructions operable to perform a method that includes, determining the operating frequency of a frequency scaleable processor, receiving a power data associated with an executable entity, and selectively scheduling the executable entity for processing by the processor based, at least in part, on the operating frequency and the power data.

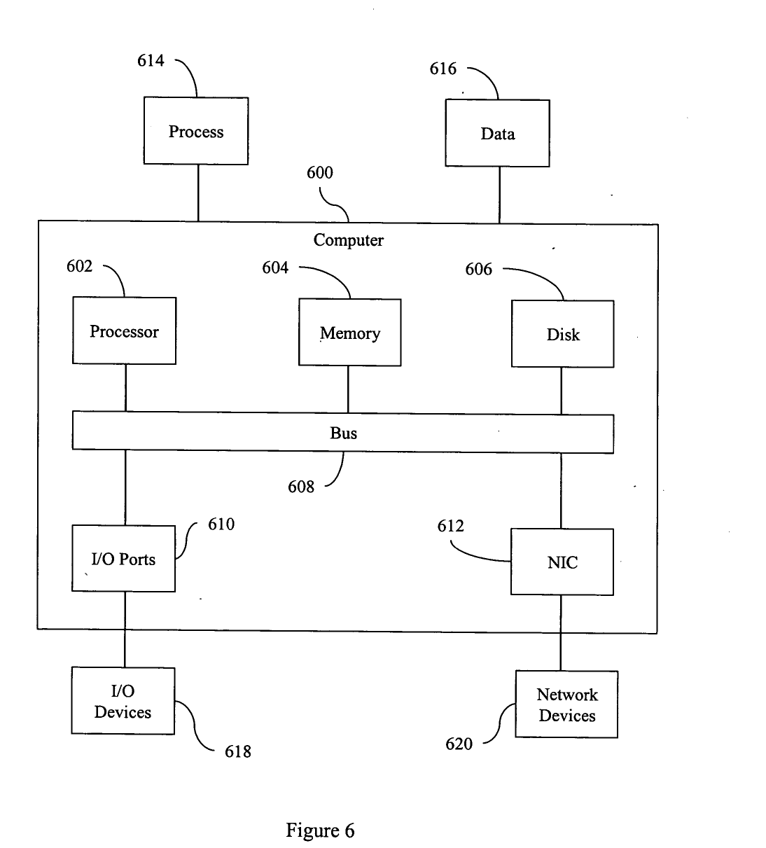

FIG. 6 illustrates a computer 600 that includes a processor 602, a memory 604, a disk 606, input/output ports 610, and a network interface 612 operably connected by a bus 608. Executable components of the systems described herein may be located on a computer like computer 600. Similarly, computer executable methods described herein may be performed on a computer like computer 600. It is to be appreciated that other computers may also be employed with the systems and methods described herein.

The processor 602 can be a variety of various processors including dual microprocessor and other multi-processor architectures. The memory 604 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like, Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 606 can include, but is not limited to, devices like a magnetic disk drive, a floppy disk drive, a tape drive, a Zip drive, a flash memory card, and/or a memory stick. Furthermore, the disk 606 can include optical drives like, a compact disc ROM (CD-ROM), a CD recordable drive (CD-R drive), a CD rewriteable drive (CD-RW drive) and/or a digital versatile ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus architectures. The bus 608 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 interacts with input/output devices 618 via input/output ports 610. Input/output devices 618 can include, but are not limited to, a keyboard, a microphone, a pointing and selection device, cameras, video cards, displays, and the like. The input/output ports 610 can include but are not limited to, serial ports, parallel ports, and USB ports.

The computer 600 can operate in a network environment and thus is connected to network devices 620 by a network interface (NIC) 612. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network interface 612 can connect to LAN technologies including, but not limited to, fiber distributed data interface (FDDI), copper distributed data interface (CDDI), Ethernet/IEEE 802.3, token ring/IEEE 802.5, wireless/IEEE 802.11, Bluetooth, and the like. Similarly, the network interface 612 can connect to WAN technologies including, but not limited to, point to point links, circuit switching networks like integrated services digital networks (ISDN), packet switching networks, and digital subscriber lines (DSL).

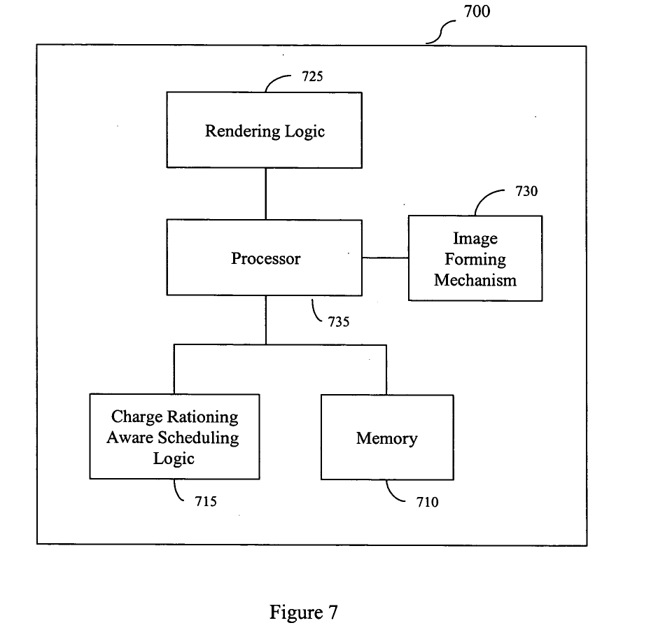

FIG. 7 illustrates an example image forming device 700 in which the example charge rationing aware systems and methods may operate. The image forming device 700 may include a memory 710 configured to store print data, for example, or to be used more generally for image processing. The image forming device 700 may also include a frequency scaleable processor 735. Thus, the image forming device 700 may include a charge rationing aware scheduling logic 715 that can analyze data provided by the processor 735 to determine, for example, which process(es) and/or print job(s) should be processed and/or scheduled to be processed. In one example the analysis is performed substantially in real time.

The image forming device 700 may receive print data to be rendered. Thus, the image forming device 700 may include a rendering logic 725 configured to generate a printer-ready image from print data. Rendering varies based on the format of the data involved and the type of imaging device. In general, the rendering logic 725 converts high-level data into a graphical image for display or printing (e.g., the print-ready image). For example, one form is ray-tracing that takes a mathematical model of a three-dimensional object or scene and converts it into a bitmap image. Another example is the process of converting HTML into an image for display/printing. It is to be appreciated that the image forming device 700 may receive printer-ready data that does not need to be rendered and thus the rendering logic 725 may not appear in some image forming devices.

The image forming device 700 may also include an image forming mechanism 730 configured to generate an image onto print media from the print-ready image. The image forming mechanism 730 may vary based on the type of the imaging device 700 and may include a laser imaging mechanism, other toner-based imaging mechanisms, an ink jet mechanism, digital imaging mechanism, or other imaging reproduction engine. In one example, the processor 735 includes logic that is capable of executing Java instructions. Other components of the image forming device 700 are not described herein but may include media handling and storage mechanisms, sensors, controllers, and other components involved in the imaging process.

While single processor systems have been described, it is to be appreciated that the example charge rationing systems and methods described herein may operate in a multiprocessor system. Thus, in one example, a system may include one or more frequency scaleable main processors and a memory operably connected to the main processors so that the main processors can access the memory. The system may also include a charge rationing aware scheduling logic operably connected to the main processors. The charge rationing aware scheduling logic may be configured to determine the charge rationing status of the processors. The charge rationing aware scheduling logic may also be configured to examine power attributes associated with executables stored in the memory, where the executables are waiting to be scheduled for execution.

Thus, the charge rationing aware scheduling logic may be configured to select an executable for execution by a processor based, at least in part, on the charge rationing status of one or more of the processors and the power attributes associated with the executable. The charge rationing aware scheduling logic may then generate a signal that causes the executable to be scheduled (e.g., placed in a process queue). The multiprocessor system may also include, for example, a test processor that facilitates characterizing the effect a process may have on a charge rationing (e.g., frequency scaling) processor.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on employed in charge rationing aware scheduling. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A system, comprising:
a scheduling logic configured to:
determine a charge rationing status of a frequency scaleable processor;
examine one or more selected properties of one or more executables to be scheduled for execution on the processor;
select an executable for execution by the processor based, at least in part, on the charge rationing status of the processor and the one or more selected properties; and
generate a signal that causes the executable to be scheduled for execution.

2. The system of claim 1, where the charge rationing status can be determined by evaluating an operating frequency of the processor.

3. The system of claim 1, where the charge rationing status can be determined by evaluating one or more of, an operating frequency of the processor, an operating frequency history of the processor, an amount by which the operating frequency of the processor changed, and a frequency shift indicator.

4. The system of claim 1, where the scheduling logic is further configured to:
examine a processor data associated with the processor; and
select the executable for execution by the processor based, at least in part, on the processor data, the charge rationing status of the processor, and one or more of the selected properties.

5. The system of claim 4, where the processor data describes one or more of, a processor temperature, a temperature history of the processor, changes in the processor temperature, a processor power consumption, a processor power consumption history, changes in the processor power consumption, a current flowing through the processor, a history of current flowing through the processor, and changes in the current flowing through the processor.

6. The system of claim 1, where the one or more selected properties describe one or more of, an identity of an executable, whether an executable is associated with a processor frequency decrease, whether an executable is associated with a processor frequency increase, whether an executable is associated with a stable processor frequency, and one or more power attributes.

7. The system of claim 1, where the executable is one or more of, a process, and a thread.

8. The system of claim 1, where the charge rationing status of the frequency scaleable processor can be determined by processing an interrupt from the processor.

9. The system of claim 1, where the charge rationing status of the frequency scaleable processor can be determined by processing a charge rationing data associated with the processor status.

10. The system of claim 9, where the charge rationing data can be stored in one or more registers located inside the processor.

11. The system of claim 1, comprising:
a schedule data store configured to store a schedule data associated with an order in which one or more executables are to be executed by the processor; and
where the scheduling logic is further configured to:
determine an execution order for the one or more executables based, at least in part, on the charge rationing status of the processor, the schedule data, and the one or more selected properties; and
generate one or more signals that cause a selective arrangement of the schedule data in the schedule data store.

12. The system of claim 11, where the schedule data store is a process queue.

13. The system of claim 11, where the scheduling logic is further configured to selectively cause reordering of the schedule data in the schedule data store in response to the charge rationing status of the processor changing.

14. The system of claim 11, comprising:
a test processor configured to:
execute an executable;
monitor one or more properties of one or more of, the test processor, and the executable while the executable is executing; and
produce one or more characterizing data that characterize the executable with respect to one or more attributes associated with executing on the test processor.

15. The system of claim 14, where the characterizing data describe one or more of, an actual power rating during execution, an anticipated power rating during execution, an actual execution time, an anticipated execution time, an actual heat produced during execution, an anticipated heat produced during execution, an actual current during execution, and an anticipated current during execution.

16. The system of claim 14, where the scheduling logic is further configured to determine an execution order for an executable based, at least in part, on the charge rationing status of the processor, the one or more selected properties, and the characterizing data.

17. The system of claim 1, where the system is embedded in an image forming device.

18. The system of claim 1, where the system is embedded in a computer.

19. The system of claim 1, where the system is embedded in a cellular telephone.

20. A method, comprising:
determining an operating frequency of a frequency scaleable processor;
examining a power data associated with a process; and
selectively scheduling the process for processing by the processor based, at least in part, on the operating frequency of the processor, and the power data.

21. The method of claim 20, where the power data describes one or more events associated with the processor processing the process.

22. The method of claim 21, where the events include one or more of, the process not previously being run, the operating frequency of the processor increasing during processing, the operating frequency of the processor decreasing during processing, and the operating frequency of the processor not changing during processing.

23. The method of claim 20, where selectively scheduling the process for processing includes generating one or more signals that cause the processor to process the process.

24. The method of claim 20, where selectively scheduling the process for processing includes generating one or more signals that cause the process to be logically located at a selected location in a data structure that is organized by process schedule order.

25. The method of claim 20, where selectively scheduling the process for processing includes storing one or more values in a data structure that is organized by process schedule order.

26. The method of claim 20, comprising:
examining a processor data associated with the frequency scaleable processor; and
selectively scheduling the process for processing based, at least in part, on the processor data, the operating frequency of the processor, and the power data.

27. The method of claim 26, where the processor data describes one or more of, a processor temperature, a processor temperature history, a change in the processor temperature, a processor power consumption, a processor power consumption history, a change in the processor power consumption, a current flowing through the processor, a processor current history, and a change in current flowing through the processor.

28. A system, comprising:
one or more frequency scaleable main processors;
a memory operably connected to one or more of the main processors, where one or more of the main processors can access the memory; and
a charge rationing aware scheduling logic operably connected to one or more of the main processors, where the charge rationing aware scheduling logic is configured to:
determine a charge rationing status of one or more of the one or more processors;
examine power attributes associated with one or more executables stored in the memory, where the executables are to be scheduled for execution on one or more of the one or more main processors;
select an executable for execution by one or more of the one or more main processors based, at least in part, on the charge rationing status of one or more of the main processors and the power attributes associated with the executable; and
generate a signal that causes the executable to be scheduled for execution.

29. The system of claim 28, comprising:
a test processor configured to:
execute an executable;
monitor one or more properties of one or more of, the test processor, and the executable, while the executable is executing; and
produce one or more characterizing data that characterize the executable with respect to one or more attributes associated with executing on the test processor.

30. A computer-readable medium storing processor executable instructions operable to perform a method, the method comprising:
determining an operating frequency of a frequency scaleable processor;
receiving a power data associated with an executable entity; and
selectively scheduling the executable entity for processing by the frequency scaleable processor based, at least in part, on the operating frequency and the power data.

31. A system, comprising:
means for determining an operating frequency of a frequency scaleable processor;
means for determining a change in the operating frequency of the frequency scaleable processor;
means for evaluating one or more power attributes associated with an executable entity; and
means for scheduling the executable entity for execution on the frequency scaleable processor based, at least in part, on the operating frequency, the change in operating frequency, and the power attributes.

32. A system, comprising:
means for receiving a processor frequency data associated with a processor;
means for receiving a processor power data associated with a process; and
means for scheduling the process to execute on the processor based, at least in part, on the processor frequency data and the process power data.
